(19) United States
(12) Patent Application Publication
(10) Pub. No.: US 2009/0197030 A1
(43) Pub. Date: Aug. 6, 2009

(54) FIXING BELT, METHOD FOR MANUFACTURING FIXING BELT, AND FIXING DEVICE

(76) Inventors: Takashi MUKAI, Yamatokoriyama-shi (JP); Toshiaki Kagawa, Kitakatsuragi-gun (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/363,171

(22) Filed: Jan. 30, 2009

(30) Foreign Application Priority Data
Feb. 4, 2008 (JP) 2008-024398

(51) Int. Cl. B32B 1/08; B05D 3/00

(52) U.S. Cl. 428/36.91; 427/379

(57) ABSTRACT

A method of the present invention for manufacturing a fixing belt has the step of covering an outer circumferential surface of a hollow cylindrical mold with a fluorocarbon resin tube that is to be a releasing layer, prepares a hollow cylindrical product by forming an elastic layer and a base material layer in this order on the releasing layer, and then turns over the hollow cylindrical product. Such a method for manufacturing a fixing belt makes it possible to obtain a fixing belt of the present invention in which a releasing layer serving as an outermost layer is constituted by a fluorocarbon resin tube having a heat shrinkage ratio of not more than 5%. This makes it possible to provide: a fixing belt that is more inexpensive than before while having a releasing layer constituted by a highly durable fluorocarbon resin tube; and a fixing device including the same.

This Nonprovisional application claims priority under U.S.C. §119(a) on Patent Application No. 024398/2008 filed in Japan on Feb. 4, 2008, the entire contents of which are hereby incorporated by reference.

### FIELD OF THE INVENTION

The present invention relates to fixing devices, mounted in electrophotographic image forming apparatuses for use in copying machines, laser printers, facsimiles, etc., which fix toner images on recording media. More specifically, the present invention relates to a fixing device in which a fixing belt is used.

### BACKGROUND OF THE INVENTION

Electrophotographic image forming apparatuses are widely used in copying machines, laser printers, facsimiles, etc. In such an electrophotographic image forming apparatus, a latent-image bearing member on a surface of which a photosensitive layer containing a photoconducting substance has been formed is used. After the latent-image bearing member is uniformly charged by imparting an electric charge to the surface of the latent-image bearing member, an electrostatic latent image corresponding to image information is formed by various image-forming processes. The electrostatic latent image is developed as a toner image with a developer supplied from developing means. The toner image is either transferred directly onto a recording medium such as a sheet of paper, or transferred first onto an intermediate medium and then onto a recording medium such as a sheet of paper. It should be noted that there are two types of developer, namely a one-component developer composed solely of carrier and a two-component developer composed of toner and carrier.

The toner image transferred onto the recording medium is then fixed onto the recording medium by a fixing device. Generally, toner images are fixed by a heat fixing method. Conventionally, a heat roller fixing method has been generally used. According to the heat roller fixing method, a pair of (i) a heat roller, having a thermal heater therein, whose outer circumferential surface has been covered with highly releasable rubber or resin and (ii) a rubber roller are pressed against each other, and a sheet of transfer paper on which a toner image has been formed is passed through the space between the rollers. In the space, the toner image is fused onto the sheet of transfer paper by heating and melting toner of the toner image. The heat roller fixing method is suitable for speeding up because the entire heat roller is held at a predetermined temperature.

In recent years, a full-color image forming apparatus such as a full-color laser printer uses four colors of toner, namely magenta toner, yellow toner, cyan toner, and black toner. In order to fix a full-color toner image, it is necessary to mix plural types of color toner in an almost molten state, unlike in the case of a monochrome toner image that is fixed simply by softening toner under pressure. This makes it necessary to put the toner in a molten state.

For this reason, according to the method for heat roller fixing in a full-color image forming apparatus, a heat roller is constituted by a supporting member made for example of metal and an elastic member, made for example of silicone rubber and formed on the supporting member, whose surface has been covered with a highly releasable fluorocarbon resin. A pair of such heat rollers are pressed against each other, and a sheet of transfer paper on which a toner image has been formed is passed through the space between the rollers. In the space, the toner image is fused onto the sheet of transfer paper by heating and melting toner.

This makes necessary to heat the heat rollers, each of which has a rubber layer that is low in heat conductivity, to a predetermined temperature at the time of start of operation of the apparatus, thus requiring a waiting period between a point of time where the apparatus is powered on and a point of time where the apparatus becomes ready for operation. Further, since the heat rollers must be heated entirely, a large amount of power is required.

In view of this, there has recently been proposed a fixing method including heating toner on a sheet of transfer paper with a heater via a hollow cylindrical fixing belt. According to the method for belt fixing with use of a hollow cylindrical fixing belt, the hollow cylindrical fixing belt and a rubber roller are pressed against each other, and a sheet of transfer paper on which a toner image has been formed is passed through the space between the fixing belt and the rubber roller. In the space, the toner is fused and fixed to the sheet of transfer paper by the heat of the belt. According to this fixing method, the hollow cylindrical belt that is heated is thin and low in thermal capacity; therefore, a surface of the belt reaches a predetermined temperature in a short period of time. This makes it possible to significantly reduce a waiting period after power-on.

Conventional heat rollers have been manufactured by an integral molding method for forming a heat roller by covering an inner surface of a roller mold with a fluorocarbon resin tube, placing a cored bar into the mold, and then pouring silicone rubber into the space between the tube and the cored bar.

However, the hollow cylindrical belt for use in the belt fixing method cannot be manufactured by the conventional integral molding method because the hollow cylindrical belt has an elastic layer constituted by a thin silicone rubber layer that makes it difficult to uniformly pour rubber material.

Patent Documents 1 and 2 describe techniques that make it possible to manufacture such a fixing belt having a thin elastic layer. According to Patent Document 1, a fluorocarbon resin tube is passed thorough an empty space inside of a hollow cylindrical mold having the outside diameter of a fixing belt to be formed, and both ends of the fluorocarbon resin tube are folded back onto the outer side of the mold. A core provided with a heat-resistant resin layer is placed into the fluorocarbon resin tube so as to have the same center as the mold. The fluorocarbon resin tube and the core provided with the heat-resistant resin layer are fixed by fitting mold lids on both ends of the mold. After that, silicone rubber serving as a precursor of an elastic material layer is poured via resin inlets of the mold lids into the space between the fluorocarbon resin tube and the core provided with the heat-resistant resin layer, with the result that the space between the fluorocarbon resin tube and the core provided with the heat-resistant resin layer is filled within the mold. After that, the precursor is cross-linked and cured, normally, by heating the whole mold (first vulcanization). After appropriate curing, an integrated combination of the core, the elastic material layer, and the covering resin layer are stripped from the mold, and then further heated and cross-linked (second vulcanization). After that, the core is removed, with the result that a fixing film of the present invention is obtained.

Meanwhile, according to Patent Document 2, a releasing layer constituted by a fluorocarbon resin is applied onto an outer circumferential surface of a mold, and a first adhesive layer is applied onto the releasing layer. After these layers are calcined at a predetermined temperature, an elastic layer is applied onto the first adhesive layer and then calcined at a predetermined temperature. Next, a second adhesive layer is applied onto the elastic layer and dried. Then, a supporting layer is applied onto the second adhesive layer and then calcined at a predetermined temperature, with the result that an annular product is formed. After that, the annular product is turned over. Thus obtained is a fixing belt including: an outermost layer serving as a releasing layer, made of a fluorocarbon resin, whose outer surface is a molded surface; an innermost layer serving as a supporting layer; and an elastic layer provided between the outermost layer and the innermost layer.

### [Patent Document 1]

Japanese Unexamined Patent Application Publication No. 15303/1999 (Tokukaihei 11-15303; published on Jan. 22, 1999)

### [Patent Document 2]

Japanese Unexamined Patent Application Publication No. 84593/2003 (Tokukai 2003-84593; published on Mar. 19, 2003)

### [Patent Document 3]

Japanese Unexamined Patent Application Publication No. 25442/2003 (Tokukai 2003-25442; published on Jan. 29, 2003)

### SUMMARY OF THE INVENTION

However, the conventional manufacturing methods suffer from the following problems. That is, since the manufacturing method of Patent Document 1 requires the fluorocarbon resin tube to be thermally shrinkable, thus imposing limitations on the type of fluorocarbon resin tube that can be used.

Further, the fixing belt manufactured by the manufacturing method of Patent Document 2 is superior in smoothness, toner releasability, and durability of the belt surface to the conventional coating-type fixing belt, but inferior in durability to the tube-type fixing belt. Further, the manufacturing method of Patent Document 2 requires a high-precision mold of high dimensional accuracy, thus making the fixing belt expensive.

It is an object of the present invention to provide: a fixing belt having a releasing layer constituted by a highly durable fluorocarbon resin tube; a fixing device including the same; and a method for manufacturing a fixing belt.

In order to solve the foregoing problems, a fixing belt of the present invention is a fixing belt, shaped into a hollow cylinder, which has a base material layer formed on an inner circumferential side thereof, has a releasing layer formed on an outer circumferential side thereof, and has an elastic layer formed between the base material layer and the releasing layer, the releasing layer being constituted by a fluorocarbon resin tube having a heat shrinkage ratio of not more than 5%.

According to this, the releasing layer formed on the outer circumferential side of the belt is constituted by the fluorocarbon resin tube. As such, the releasing layer is superior in durability to a releasing layer formed by applying a resin containing a fluorocarbon resin and calcining the resin.

Further, in the case of formation of a releasing layer by application and calcination, an attempt to obtain a releasing layer of high dimensional accuracy requires a high-precision and expensive mold. In contrast, use of a tube makes it possible to obtain a releasing layer of high dimensional accuracy without use of such a mold.

Moreover, according to this, use of a fluorocarbon resin tube, having a heat shrinkage ratio of not more than 5%, which has conventionally been unable to be used as a releasing layer makes it possible to attain equivalent effects more inexpensively than before with a wide range of material choice.

Further, the present invention further encompasses: a fixing device including the fixing belt of the present invention; and an image forming apparatus including such a fixing device.

As already explained, the fixing belt of the present invention can be manufactured inexpensively with use of a fluorocarbon resin tube having a heat shrinkage ratio of not more than 5%. Therefore, the fixing device and the image forming apparatus including the same can be lowered in price. Furthermore, in cases where the fluorocarbon resin tube has a tensile strength of not less than 80 MPa, it is possible to further improve durability or, provided durability is maintained at the same level as is conventionally done, to make the fluorocarbon resin tube thinner than before. Therefore, the elasticity of the elastic layer can be further utilized. This makes it possible for a surface of a fixing member to follow fine undulations of a sheet of paper, thus making it possible to obtain a good quality image.

In order to solve the foregoing problems, a method of the present invention for manufacturing a fixing belt is a method of the present invention for manufacturing a hollow cylindrical fixing belt in which an elastic layer and a releasing layer have been provided in this order on a base material layer, the method comprising the steps of: covering an outer circumferential surface of a hollow cylindrical mold with a fluorocarbon resin tube that is to be the releasing layer; applying the elastic layer onto the fluorocarbon resin tube; calcining at a predetermined temperature the elastic layer thus applied; applying the base material layer onto the elastic layer thus calcined; calcining at a predetermined temperature the base material layer thus applied; and after the base material has been calcined, turning over a hollow cylindrical product constituted by the fluorocarbon resin tuber, the elastic layer, and the base material layer.

According to this, the fluorocarbon resin tube is used as the releasing layer formed on the outer circumferential side of the belt. Therefore, in comparison with a method for forming a releasing layer by applying a resin containing a fluorocarbon resin and calcining the resin, the method makes it possible to manufacture, without use of a high-precision and expensive mold, a fixing belt excellent in durability and having a releasing layer of high dimensional accuracy.

Moreover, the method does not utilize the heat shrinkage of a fluorocarbon resin tube. Therefore, the method makes it possible to use a fluorocarbon resin tube, having a heat shrinkage ratio of not more than 5%, which has conventionally been unable to be used as a releasing layer in a conventional method that utilizes the heat shrinkage of a fluorocarbon resin tube. This widens a range of choice of a fluorocarbon resin tube to form a releasing layer.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1, showing an embodiment of the present invention, shows the way a fixing belt to be provided in a fixing device looks in course of manufacture.

FIG. 2 is a schematic diagram showing an arrangement of an image forming apparatus including the fixing device.

FIG. 3 is a schematic diagram showing an arrangement of an image-forming unit in the image forming apparatus.

FIG. 4 is a cross-sectional view showing an arrangement of the fixing device in detail.

FIG. 5 is a process drawing showing a procedure for manufacturing the fixing belt.

### DESCRIPTION OF THE EMBODIMENTS

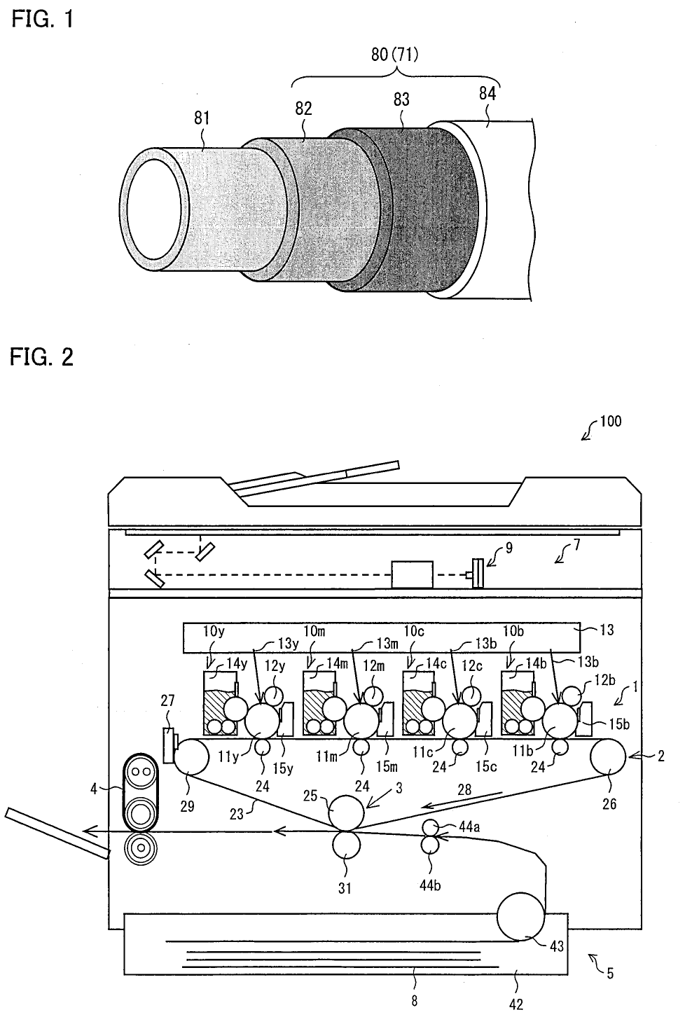

An embodiment of the present invention will be described below with reference to FIGS. 1 through 5. It should be noted that the present invention is not limited to this.

FIG. 2 is a schematic diagram showing an arrangement of an image forming apparatus 100 including a fixing device 4 of the present invention. As shown in FIG. 2, the image forming apparatus 100 includes an image forming section (image forming means) 1, an intermediate transfer section (intermediate transfer means) 2, a second transfer section (second transfer means) 3, the fixing device 4, and a recording medium supplying section (recording medium supplying means) 5.

The image forming section 1 includes image-forming units 10y, 10m, 10c, and 10b. The image-forming units 10y, 10m, 10c, and 10b form electrostatic latent images corresponding to digital signals representing the respective colors (such digital signals being hereinafter referred to as “image information”), develop the electrostatic latent images, and form images with the respective colors of toner. That is, the image-forming unit 10y forms a toner image corresponding to image information representing yellow. The image-forming unit 10m forms a toner image corresponding to image information representing magenta. The image-forming unit 10c forms a toner image corresponding to image information representing cyan. The image-forming unit 10b forms a toner image corresponding to image information representing black.

The image-forming units 10y, 10m, 10c, and 10b are identical in structure to one another, except that the image-forming units 10y, 10m, 10c, and 10b use a yellow developer, a magenta developer, a cyan developer, and a black developer, respectively and that the image-forming units 10y, 10m, 10c, and 10b receives pixel signals, contained in image information received by the image forming means 1, which correspond to a yellow component, a magenta component, a cyan component, and a black component, respectively. In the following, the image-forming unit 10y, which corresponds to yellow, will be shown as a representative example, and the other image-forming units will not described.

It should be noted that in cases where the image-forming units, etc. corresponding to the respective colors are individually shown, the image-forming units, etc. are indicated by additional letters of the alphabet “y (yellow), “m (magenta)”, “c (cyan)”, and “b (black)”. The image-forming units 10y, 10m, 10c, and 10b are lined in this order from an upstream side to a downstream side of the moving direction (auxiliary control direction) of an intermediate transfer belt 23 serving as an intermediate transfer member, i.e., the direction of an arrow 28.

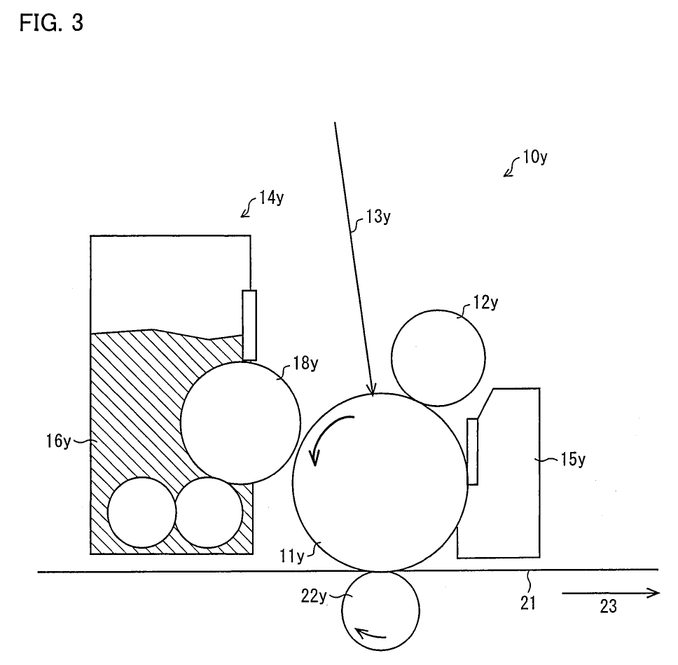

As shown in FIG. 3, the image-forming unit 10y includes: a photoreceptor drum 11y, on a surface of which a yellow toner image is formed; a charging roller 12y, which uniformly charges the surface of the photoreceptor drum 11y; a light scanning unit 13, which forms an electrostatic latent image by exposing the charged surface of the photoreceptor drum 11y with light corresponding to image information; a developing device 14y, which forms a toner image by causing toner to adhere to the electrostatic latent image formed on the surface of the photoreceptor drum 11y; and a drum cleaner 15y, which removes and collects toner remaining on the surface of the photoreceptor drum 11y without being transferred onto the intermediate transfer belt 23. It should be noted that FIG. 3 is a schematic diagram showing an arrangement of the image-forming unit 10y.

The photoreceptor drum 11y is a latent-image bearing member, provided rotatably, on a surface of which an electrostatic latent image is formed by exposure with light corresponding to image information. The photoreceptor drum 11y is supported by a driving mechanism (driving means; not shown) so as to be able to be driven to rotate on an axis line, and includes a hollow cylindrical, unhallowed cylindrical, or filmy (preferably hollow cylindrical) conductive substrate and a photosensitive layer formed on a surface of the conductive substrate.

The photoreceptor drum 11y can be realized by a photoreceptor drum 11y for regular use in this field. An example is a photoreceptor drum 11y, connected to GND (Ground) potential, which has a diameter of 30 mm and includes an aluminum base tube serving as a conductive substrate and an organic photosensitive layer formed on a surface of the aluminum base tube so as to serve as a photosensitive layer.

The organic photosensitive layer may be a laminate of a charge-generating layer containing a charge generating substance and a charge transporting layer containing a charge transporting substance, or may be a single layer containing a charge generating substance and a charge transporting substance. The organic photosensitive layer is not particularly limited in thickness; for example, the organic photosensitive layer has a thickness of 20 μm. Further, there may be a foundation layer provided between the organic photosensitive layer and the conductive substrate. Furthermore, there may be a protective layer provided on a surface of the organic photosensitive layer.

The photoreceptor drum 11y is driven to rotate, for example, at a peripheral velocity of 173 mm/s in a counterclockwise direction on FIG. 2 or 3. The driving mechanism (driving means) of the photoreceptor drum 11y is controlled by a control device (control means; not shown), whereby the rotation speed of the photoreceptor drum 11y is controlled.

The charging roller 12y is a charging device (charging means) for charging the surface of the photoreceptor drum 11y at a potential of a predetermined polarity. The charging means is not limited to the charging roller 12y. The charging means can be realized by a brush-type charger, or a corona charger such as a scorotron charger or a corotron charger, instead of the charging roller 12y.

The light scanning unit 13 is a latent-image forming section) latent-image forming means for irradiating the surface of the photoreceptor drum 11y in a charged state with laser light 13y corresponding to yellow image information and thereby forming, on the surface of photoreceptor drum 11y, an electrostatic latent image corresponding to the yellow image information. The layer light comes from a light source such as a semiconductor laser element.

The developing device 14y is a developing device (developing means), provided so as to face the photoreceptor drum 11y, which conveys a yellow developer 16y to the surface of the photoreceptor drum 11y, develops an electrostatic latent image formed on the surface of the photoreceptor drum 11y, and thereby makes the electrostatic latent image visible. The yellow developer 16y, carried on a surface of a developing sleeve 18y, contains yellow toner and carrier. The developing device 14y may use a one-component developer, i.e., a developer containing no carrier.

In a developing nip area where the developing sleeve 18y comes close to the photoreceptor drum 11y, the developing sleeve 18y is driven to rotate in the same direction as the photoreceptor drum 11y is driven to rotate. Therefore, the developing sleeve 18y is driven to rotate on an axis line in a direction opposite to the photoreceptor drum 11y. Further, in the present embodiment, the developing sleeve 18y is driven to rotate at a peripheral velocity 1.5 times as high as the photoreceptor drum 11y, i.e., at a peripheral velocity of 260 mm/s.

The drum cleaner 15y removes and collects yellow toner remaining on the surface of the photoreceptor drum 11y after the intermediate transfer of a yellow toner image from the surface of the photoreceptor drum 11y onto the intermediate transfer belt 23.

The following details the constituents of each of the developers 16y, 16m, 16c, and 16b that are used for the image forming apparatus 100 of the present embodiment.

The toner contains a binder resin, a colorant, and a releasing agent. The binder resin can be realized by a binder resin for regular use in this field. Examples of such a resin binder include polystyrene, a homopolymer of a derivative substitution of styrene, a styrene-based copolymer, polyvinyl chloride, polyvinyl acetate, polyethylene, polypropylene, polyester, and polyurethane. It is possible to use one type of binder resin alone or to use two or more types of binder resin together.

Among these binder resins, a binder resin having a softening point of 100° C. to 150° C. and a glass transition temperature of 50° C. to 80° C. is preferably used for color toner in terms of storage stability and durability. In particular, polyester is preferred because it has the above softening point and glass transition temperature. Polyester exhibits a high degree of transparency in a softened or molten state. In cases where the binder resin is polyester, sufficient coloring is obtained by subtractive color mixing, because polyester becomes transparent when a multicolor toner image produced by superimposing yellow, magenta, cyan, and black toner images onto one another is fixed onto a recording medium 8.

The colorant can be realized by a toner pigment and a toner dye that have conventionally been used for the electrophotographic image forming technique. Examples of the pigment include: organic pigments such as an azo pigment, a benzimidazolone pigment, a quinacridone pigment, a phthalocyanine pigment, an isoindolinone pigment, an isoindoline pigment, a dioxazine pigment, an anthraquinone pigment, a perylene pigment, a perynone pigment, a thioindigo pigment, a quinophthalone pigment, and a metal-complex pigment; inorganic pigments such as carbon black, titanium oxide, molybdenum red, chromium yellow, titanium yellow, chromium oxide, and Berlin blue; and metal powder such as aluminum powder. It is possible to use one type of pigment alone or to use two or more types of pigment together.

The releasing agent can be realized, for example, by wax. The wax can be realized by wax for regular use in this field. Examples of such wax include polyethylene wax, polypropylene wax, and paraffin wax. In addition to the binder resin, the colorant, and the releasing agent, the toner can contain one or more types of common toner additive such as a charging control agent, a flow improver, a fixing accelerator, and a conductive agent.

The toner can be manufactured by a publicly-known method such as a crushing method for crushing a molten mixture of a binder resin with a colorant, a releasing agent, etc., a suspension polymerization method for, after uniformly dispersing a colorant, a releasing agent, and monomers of a binder resin, polymerizing the monomers of the binder resin, or an emulsion condensation method for heating fine particles of a product of condensation of binder resin particles, a colorant, a releasing agent, etc.

The toner is not particularly limited in volume average particle diameter; however, it is preferable that the toner have a volume average particle diameter of 2 μm to 7 μm. In cases where the toner has such an appropriately small volume average particle diameter, there is an increase in coverage of a recording medium by the toner. This makes it possible to improve image quality with a small amount of adhesion and to reduce toner consumption.

In cases where the toner has a volume average particle diameter of less than 2 μm, there is a decrease in fluidity of the toner. Such a decrease in fluidity of the toner causes the toner to be supplied, stirred, and charged insufficiently during a developing operation. Such insufficiency causes a lack in amount of toner, an increase in reverse-polarity toner, etc. This may make it impossible to obtain a high-quality image. On the other hand, in cases where the toner has a volume average particle diameter of more than 7 μm, there is an increase in large toner particles whose central portions are hard to soften. This causes a decrease in fixability of an image onto a recording medium 8 and deterioration in coloring of the image. In particular, in the case of fixation to an OHP sheet, the image is darkened.

The colors of toner for use in the present embodiment are identical in constitution to one another except for the colorants. The toner is negatively-charged insulating nonmagnetic toner, for example, having a glass transition temperature of 60° C., a softening point of 120° C., and a volume average particle diameter of 6 μm. The amount of toner required to obtain, with use of the toner, an image density at which a measured value of reflected density by an X-Rite 310 is 1.4 is 5 g/m². The toner contains: polyester, serving as a binder resin, which has a glass transition temperature of 60° C. and a softening point of 120° C.; low-molecular polyethylene wax, serving as a releasing agent, which has a glass transition temperature of 50° C. and a softening point of 70° C.; and a pigment, serving as a colorant, which has the corresponding color. The content of wax is 7 wt % of the total amount of toner. The content of the pigment is 12 wt % of the total amount of toner. The remnant is the polyester serving as a binder resin.

The low-molecular polyethylene wax contained in the toner is wax lower in glass transition temperature and softening point than the polyester serving as a binder resin. Use of such wax causes increases in adhesion of toner to toner and adhesion of toner to the intermediate transfer belt 23 or a recording medium even at a temperature lower than the glass transition temperature of the binder resin. This makes it possible to prevent the occurrence of toner flow, toner condensation, etc. by a liquid fixer at the time of imparting the liquid fixer. Furthermore, when the wax contained in the toner is softened, the liquid fixer easily penetrates into the toner through the portion where the wax exists. Therefore, the entire toner is softened or swollen in a short period of time at the time of imparting the liquid fixer. This makes it possible to obtain a sufficient fixing intensity at the time of transfer to a recording medium and to obtain sufficient coloring by superimposition of toner images.

Each of the developers 16y, 16m, 16c, and 16b may contain carrier in addition to the toner. The carrier can be realized by magnetic particles. Specific examples of the magnetic particles include: metals such as iron, ferrite, and magnetite; and an alloy of these metals and a metal such as aluminum or lead. Among these, ferrite is preferred.

Alternatively, the carrier may be realized by resin-covered carrier obtained by covering magnetic particles with a resin or resin-dispersed carrier obtained by dispersing magnetic carrier in resin. Examples of the resin with which the magnetic particles are covered include, but are not particularly limited to, an olefin resin, a styrene resin, an acrylic styrene resin, a silicone resin, an ester resin, and a fluorine-containing polymer-based resin. Further, examples of the resin that is used for the resin-dispersed carrier include, but are not particularly limited to, an acrylic styrene resin, a polyester resin, a fluorocarbon resin, and a phenol resin.

It is preferable that the carrier has a spherical or flat shape. Further, the carrier is not particularly limited in volume average particle diameter. However, in consideration of improvement in image quality, it is preferable that the carrier have a volume average particle diameter of not less than 30 μm to not more than 50 μm. Furthermore, it is preferable that the carrier have a resistivity of not less than 10⁸ Ω·cm or more preferably not less than 10¹² Ω·cm. The resistivity of the carrier is a value that is obtained by pouring the carrier into a container having a cross-sectional area of 0.50 cm², tapping the container, applying a load of 1 kg/cm² to the particles packed in the container, and reading the value of a current when a voltage at which an electric field of 1,000 V/cm is generated is applied between the load and the base electrode. In the case of low resistivity, application of a bias voltage to the developing sleeve 18 causes charge injection into the carrier. This makes it easier for the carrier particles to adhere to the photoreceptor drum 11. This also makes it easier for the bias voltage to break down.

It is preferable that the carrier have an intensity of magnetization (maximum magnetization) of 10 emu/g to 60 emu/g, or more preferably 15 emu/g to 40 emu/g. The intensity of magnetization depends on the magnetic flux density of the developing sleeve 18. Under normal conditions for intensity of magnetization of the developing sleeve 18, an intensity of magnetization of less than 10 emu/g may cause carrier scattering because no magnetic biding force acts. Meanwhile, in the case of an intensity of magnetization of more than 60 emu/g, noncontact development, in which the carrier is raised too high, makes it difficult to keep the carrier out of contact with the photoreceptor drum 11, which serves as a latent-image bearing member. Further, contact development may make it likely for a toner image to show scratches.

The ratio between the amounts of toner 101 and carrier used in each of the developers 16y, 16m, 16c, and 16b is not particularly limited, and only needs to be selected appropriately in accordance with the types of toner 101 and carrier.

In the image-forming unit 10y, the surface of the photoreceptor drum 11y is charged, for example, to −600 V by applying −1,200 V to the charging roller 12y with a power supply (not shown) while driving the photoreceptor drum 11y to rotate on its axis line. Next, the light scanning unit 13 irradiates the charged surface of the photoreceptor drum 11y with laser light 13y corresponding to yellow image information and thereby forms an electrostatic latent image with an exposure potential of −70 V corresponding to the yellow image information.

Then, the surface of the photoreceptor drum 11y and the yellow developer carried on the surface of the developing sleeve 18y are brought into close contact with each other. The developing sleeve 18y has a direct current of −450 V applied thereto as a developing potential, and the difference in potential between the developing sleeve 18y and the photoreceptor drum 11y causes the yellow toner to adhere to the electrostatic latent image, with the result that a yellow toner image is formed on the surface of the photoreceptor drum 11y. As will be described later, the yellow toner image is intermediately transferred onto the intermediate transfer belt 23, pressed against the surface of the photoreceptor drum 11y, which is driven in the direction of the arrow 28. Yellow toner 101 remaining on the surface of the photoreceptor drum 11y is removed and collected by the drum cleaner 15y. Afterward, the operation of forming a yellow toner image is performed repeatedly in the same way.

As shown in FIG. 2, the intermediate transfer section 2 includes: the intermediate transfer belt 23; intermediate transfer rollers 24y, 24m, 24c, and 24b; supporting rollers 25, 26, and 29; and a belt cleaner 27. The intermediate transfer belt 23 is an image-bearing member, stretched over the supporting rollers 25, 26, and 29 so as to form a loop migration pathway, which takes the forms of an endless belt. The intermediate transfer belt 23 is driven to rotate at substantially the same peripheral velocity as the photoreceptor drums 11y, 11m, 11c, and 11b in the direction of the arrow 28, i.e., so that an image-bearing surface facing the photoreceptor drums 11y, 11m, 11c, and 11b moves from the photoreceptor drum 11y to the photoreceptor drum 11b.

The intermediate transfer belt 23 can be made, for example, of a polyimide film having a thickness of 100 μm. The material for the intermediate transfer belt 23 is not limited to polyimide, and may be a film constituted by a synthetic resin such as polycarbonate, polyaimde, polyester, or polypropylene or various types of rubber. With the film constituted by a synthetic resin or various types of rubber, a conductive material such as furnace black, thermal black, channel black, or graphite carbon is blended so that the electric resistance of the intermediate transfer belt 23 is adjusted. Further, the intermediate transfer belt 23 may be provided with a covering layer constituted by a fluorocarbon resin composition or fluorocarbon rubber weak in adhesion to toner. Examples of the material by which the covering layer is constituted include PTFE (polytetrafluoroethylene) and PFA (copolymer of PTFE and perfluoroalkylvinylether). With the covering layer, a conductive material may be blended.

The image-bearing surface of the intermediate transfer belt 23 is pressed against the photoreceptor drums 11y, 11m, 11c, and 11b in this order from an upstream side of the direction in which the intermediate transfer belt 23 is driven to rotate. Areas in the intermediate transfer belt 23 that are pressed against the photoreceptor drums 11y, 11m, 11c, and 11b are intermediate transfer areas where toner images of the respective colors are intermediately transferred.

The intermediate transfer rollers 24y, 24m, 24c, and 24b are roller members provided so as to face the photoreceptor drums 11y, 11m, 11c, and 11b via the intermediate transfer belt 23, respectively, pressed against a surface of the intermediate transfer belt 23 opposite the image-bearing surface, and provided so as to be able to be driven by driving mechanisms (driving means; not shown) to rotate on their respective axis lines.

Each of the intermediate transfer rollers 24y, 24m, 24c, and 24b is realized, for example, by a roller member including a metal shaft and a conductive layer covering a surface of the metal shaft. The metal shaft is made, for example, of metal such as stainless steel. The metal shaft is not particularly limited in diameter; however, it is preferable that the metal shaft have a diameter of 8 mm to 10 mm. The conductive layer is made of a conductive elastic member or the like. The conductive elastic member can be realized by a conductive elastic member for regular use in this field. Examples of such a conductive elastic member include ethylene-propylene rubber (hereinafter abbreviated as “EPDM”), EPDM foam, and urethane foam, each containing a conductive agent such as carbon black. The conductive layer causes a high voltage to be uniformly applied to the intermediate transfer belt 23.

To the intermediate transfer rollers 24y, 24m, 24c, and 24b, intermediate transfer biases whose polarities are reverse to the charging polarity of toner are applied by constant-voltage control so that toner images formed on the surfaces of the photoreceptor drums 11y, 11m 11c, and 11b are transferred onto the intermediate transfer belt 23. This causes the yellow, magenta, cyan, and black toner images formed on the surfaces of the photoreceptor drums 11y, 11m 11c, and 11b to be transferred onto the image-bearing surface of the intermediate transfer belt 23 so as to be sequentially superimposed onto one another, with the result that a multicolor toner image is formed. However, in the case of input of image information indicative of only some of the black, cyan, magenta, and yellow image information, only those of the image-forming units 10y, 10m, 10c, and 10b which correspond to the colors of the image information inputted form toner images.

Among the supporting rollers 25, 26, and 29, the supporting rollers 25 and 26, provided so as to be able to driven by driving mechanisms (driving means; not shown) to rotate on their respective axis lines, stretch the intermediate transfer belt 23 and drive the intermediate transfer belt 23 to rotate in the direction of the arrow 28. Each of the supporting rollers 25, 26, and 29 is realized, for example, by an aluminum hollow cylinder (pipe roller) having a diameter of 30 mm and a thickness of 1 mm. Among these, the supporting roller 25 is pressed against the after-mentioned second transfer roller 31 via the intermediate transfer belt 23 so that a second transfer nip area is formed, and is electrically grounded. The supporting roller 25 performs a function of stretching the intermediate transfer belt 23 and a function of making a second transfer of a toner image from the intermediate transfer belt 23 to a recording medium 8.

The belt cleaner 27 is a member, provided so as to face the supporting roller 29 via the intermediate transfer belt 23, which removes toner remaining on the image-bearing surface after an toner image on the image-bearing surface of the intermediate transfer belt 23 has been transferred to a recording medium 8 in the after-mentioned second transfer section 3.

In the intermediate transfer section 2, high voltages whose polarities are reverse to the charging polarity of toner are uniformly applied to the intermediate transfer rollers 24y, 24m, 24c, and 24b, with the result that toner images formed on the photoreceptor drums 11y, 11m, 11c, and 11b are intermediately transferred onto the image-bearing surface of the intermediate transfer belt 23 so as to be superimposed onto one another at a predetermined position. Thus formed is a toner image. As will be described later, the toner image is secondarily transferred onto a recording medium 8 in the second transfer nip area. Toner, paper powder, and the like that remain on the image-bearing surface of the intermediate transfer belt 23 after the second transfer are removed by the belt cleaner 27, and the toner image is again transferred onto the image-bearing surface.

The second transfer section 3 includes the supporting roller 25 and the second transfer roller 31. The second transfer roller 31 is a roller member pressed against the supporting roller 25 via the intermediate transfer belt 23 and provided so as to be able to be driven to rotate in the direction of its axis line. The second transfer roller 31 includes, for example, a metal shaft and a conductive layer covering a surface of the metal shaft. The metal shaft is made, for example, of metal such as stainless steel. The conductive layer is made of a conductive elastic member or the like. The conductive elastic member can be realized by a conductive elastic member for regular use in this field. Examples of such a conductive elastic member include EPDM, EPDM foam, and urethane foam, each containing a conductive agent such as carbon black. The second transfer roller 31 has a power supply (not shown) connected thereto, and a high voltage whose polarity is reverse to the charging polarity of the toner particles is uniformly applied to the second transfer roller 31. The second transfer nip area is an area where the supporting roller 25, the intermediate transfer belt 23, and the second transfer roller 31 are pressed against one another.

In the second transfer section 3, a recording medium 8 fed from the after-mentioned recording medium supplying section 5 is conveyed to the second transfer nip area at the same time as a toner image on the intermediate transfer belt 23 is conveyed to the second transfer nip area. Then, the toner image and the recording medium 8 are superimposed onto each other in the second transfer nip area, and a high voltage whose polarity is reverse to the charging polarity of toner 101 is uniformly applied to the second transfer roller 31, with the result that an image formed from toner 106 is secondarily transferred onto the recording medium 8. Then, the recording medium 8, on which the toner image is carried, is conveyed to the fixing device 4, which serves as fixing means.

The intermediate transfer section 2 and the second transfer section 3 correspond to a transfer device (transfer means) by which a toner image on a surface of a photoreceptor drum 11 serving as a latent-image bearing member is transferred onto a recording medium 8.

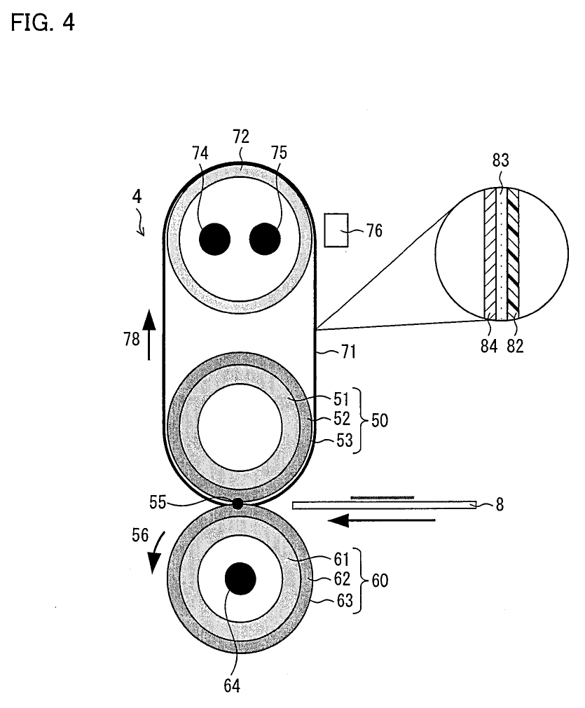

As shown in FIG. 4, the fixing device 4 includes a fixing belt 71, a fixing roller 50, a heat roller 72, and a pressure roller 60. FIG. 4 is a cross-sectional view showing an arrangement of the fixing device 4 in detail.

The fixing belt 71 is an endless belt member stretched over the fixing roller 50 and the heat roller 72 so as to form a loop migration pathway. Further, the fixing belt 71, provided so as to make contact with the pressure roller 60 at a point where the fixing roller 50 and the pressure roller 60 are pressed against each other, causes toner constituting a toner image carried on a recording medium 8 to be melted by heat to be fixed to the recording medium 8. The fixing belt 71 is driven to rotate in the direction of an arrow 78 as the pressure roller 60 is driven to rotate in the direction of an arrow 56.

In the present embodiment, the fixing belt 71 is realized by a three-layered endless belt, formed in a hollow cylindrical shape with a diameter of 50 mm so as to have a thickness of 270 μm, which includes a base material layer 84, an elastic layer 83, and a releasing layer 82.

The base material layer 84 is not particularly limited in material as long as it is made of material that excels in heat resistance and durability. However, examples of the material include heat-resistant synthetic resins. Among them, polyimide (PI), polyamide imide (PAI), and the like are preferred. These resins excel in strength, heat resistance, inexpensiveness, and the like. The base material layer 84 is not particularly limited in thickness; however, it is preferable that the base material layer 84 have a thickness of 30 μm to 200 μm. In the present embodiment uses polyimide having a thickness of 100 μm.

The elastic layer 83 is not particularly limited in material as long as it is made of material that has rubber elasticity; however, it is preferable that the material also excel in heat resistance. Specific examples of such material include silicone rubber, fluorocarbon rubber, and fluorosilicone rubber. Among these, silicone rubber is particularly preferred because it excels in rubber elasticity.

It is preferable that the elastic layer 83 have a JIS-A hardness of 1 to 60 degrees. Within this range of JIS-A hardness, it is possible to prevent a defect in fixability of toner while preventing a decrease in strength of the elastic layer 83 and a defect in adhesiveness of the elastic layer 83. Specific usable examples of the silicone rubber include: silicone rubber made up of one component, two components, or three or more components; LTV, RTV, or HTV silicone rubber; and condensation or addition silicone rubber.

Further, it is preferable that the elastic layer 83 have a thickness of 30 μm to 500 μm. Within this range of thickness, it is possible to exert an energy-saving effect by holding down thermal insulation while maintaining the elastic effect of the elastic layer 83. In the present embodiment uses silicone rubber having a JIS-A hardness of 5 degrees and a thickness of 150 μm.

The releasing layer 82 is constituted by a fluorocarbon resin tube. Since the releasing layer 82, formed on an outer circumferential side of the fixing belt 71, is composed of a fluorocarbon resin tube, the releasing layer 82 is superior in durability to a releasing layer formed by applying a resin containing a fluorocarbon resin and calcining the resin. Further, in the case of formation of a releasing layer by application and calcination, an attempt to obtain a releasing layer of high dimensional accuracy requires a high-precision and expensive mold. In contrast, use of a tube makes it possible to obtain a releasing layer of high dimensional accuracy without use of such a mold.

Moreover, the fluorocarbon resin tube constituting the releasing layer 82 has a heat shrinkage ratio of not more than 5%. Such a fluorocarbon resin tube is not particularly limited in material as long as it is made of material that excels in heat resistance and durability and is weak in adhesion to toner. Examples of the material include fluorocarbon resin materials such as PTFE (polytetrafluoroethylene) and PFA (copolymer of polytetrafluoroethylene and perfluoroalkylvinylether).

The releasing layer 82 is thus constituted by a hitherto unusable fluorocarbon resin tube that has a heat shrinkage ratio of not more than 5% and therefore does not shrink with heat. This makes it possible to attain equivalent effects more inexpensively than before with a wide range of material choice.

It is preferable that the releasing layer 82 have a thickness of 5 μm to 50 μm. Within this range of thickness, it is possible to follow fine undulations of a recording material while having an appropriate strength and utilizing the elasticity of the elastic layer. The present embodiment uses a PTFE tube having a thickness of approximately 20 μm.

Moreover, the fluorocarbon resin tube chosen to constitute the releasing layer 82 has a heat shrinkage ratio of not more than 5%. Even a fluorocarbon resin tube having such a heat shrinkage ratio can be used by using the after-mentioned method of the present invention for manufacturing a fixing belt.

The heat shrinkage ratio of the tube is calculated according to the following formula by cutting the fluorocarbon resin tube into a 200-mm-long sample tube, by covering with the sample tube an aluminum pipe having a diameter that is 90% of the inside diameter of the fluorocarbon resin tube, by placing the aluminum pipe covered with the sample tube into an oven heated to 200° C., by allowing the sample tube to shrink for 3 minutes in the oven, and by measuring the outside diameter of the sample tube after heat shrinkage.

Heat shrinkage ratio (%)=(Outside diameter of tube before heat shrinkage−Outside diameter of tube after heat shrinkage)/Outside diameter of tube after heat shrinkage×100

Furthermore, it is preferable that the fluorocarbon resin tube have a tensile strength of not less than 80 MPa. Within this range of tensile strength, it is possible-to form a releasing layer having sufficient durability. Further, it is possible to make the fluorocarbon resin tube thinner than before, provided durability is maintained at the same level as is conventionally done. This makes it possible to follow fine undulations of a recording medium 8 while utilizing the elasticity of the elastic layer 83.

The tensile strength can be calculated by conducting a tension test with use of a long narrow test piece (10 mm wide) under the following conditions: chucking interval of 50 mm, test rate of 100 mm/min. The tensile strength is a value that is obtained by dividing (a) the maximum tensile load that the test piece can withstand by (b) the cross-sectional area of the test piece in a direction perpendicular to the tensile force (i.e., the cross-sectional area before rupture). The present embodiment uses a PTFE tube having a tensile strength of 90 MPa.

The fixing roller 50 is a roller member, supported rotatably by a supporting section (supporting means; not shown), which is driven to rotate at a predetermined velocity in the direction of the arrow 56 as the pressure roller 60 and the fixing belt 71 are driven to rotate. In the present embodiment, the fixing roller 50 is realized by a roller member, formed in a hollow cylindrical shape having a diameter of 30 mm, which includes a cored bar 51, an elastic layer 52, and a surface layer 53.

The cored bar 51 can be made of highly thermally conductive metal such as aluminum or iron. The cored bar 51 can be formed in a hollow cylindrical shape, an unhollowed cylindrical shape, or the like. However, since the cored bar 51 has a low heat radiation rate when formed in a hollow cylindrical shape, it is preferable that the cored bar 51 be formed in a hollow cylindrical shape.

The elastic layer 52 is not particularly limited in material as long as it is made of material that has rubber elasticity; however, it is preferable that the material also excel in heat resistance. Specific examples of such material include silicone rubber, fluorocarbon rubber, and fluorosilicone rubber. Among these, silicone rubber is particularly preferred because it excels in rubber elasticity. It order to correct a leaning of the fixing belt 71, it is possible to arrange the fixing roller 50 to have the surface layer 53 provided on the elastic layer. This improves the surface slidability of the fixing roller 50, thus making it easy to correct a leaning of the fixing belt 71.

The surface layer 53 is not particularly limited in material as long as it is made of material that excels in heat resistance and durability and is high in slidability. Examples of the material include: fluorocarbon resin materials such as PFA (copolymer of polytetrafluoroethylene and perfluoroalkylvinylether) and PTFE (polytetrafluoroethylene); and fluorocarbon rubber.

Further, the fixing roller 50 may have a heating section (heating means) provided therein. The purpose of this is to shorten a period of warm-up time between a point of time where the image forming apparatus 100 is powered on and a point of time where the image forming apparatus 100 becomes ready for image formation and to prevent the fixing roller 50 from decreasing in surface temperature due to the transfer of heat to a recording medium 8 at the time of fixing of a toner image.

The heat roller 72 is a roller member, supported rotatably, which adds tension to the fixing belt 71 by a pressure section (pressure means; not shown). The heat roller 72 is driven to rotate as the fixing belt 71 rotates in the direction of the arrow 78. The heat roller 72 can be realized by a metal roller made of highly thermally conductive metal such as aluminum or iron. The metal roller may have a fluorocarbon resin layer formed on a surface thereof as needed.

Moreover, the heat roller 72 has heating sections (heating means) 74 and 75 provided therein. This causes the fixing belt 71 to be heated. The heating sections 74 and 75 have a power supply (not shown), connected thereto, which supplies power for heating the heating sections 74 and 75. The heating sections 74 and 75 can be realized by ordinary heating devices. The present embodiment uses halogen lamps as the heating sections 74 and 75.

The pressure roller 60 is pressed against the fixing roller 50 via the fixing belt 71 by a pressure mechanism (not shown) on a downstream side of the rotation direction of the fixing roller 50 with respect to the lowest point of the vertical direction of the fixing roller 50 so as to form a fixing nip area 55. The pressure roller 60 is driven by a driving mechanism (driving means; not shown) to rotate. The pressure roller 60 facilitates fixing of a toner image onto a recording medium 8 by pressing molten toner against the recording medium 8 when the fixing roller 50 fixes the toner image onto the recording medium 8 with heat.

In the present embodiment, the pressure roller 60 is realized by a roller member, having a diameter of 30 mm, which includes a cored bar 61, an elastic layer 62, and a surface layer 63. The cored bar 61, the elastic layer 62, and the surface layer 63 can be made of the same metal or material as the cored bar 51, the elastic layer 52, and the surface layer 53. Further, the cored bar 61 has the same shape as the fixing roller 50.

The pressure roller 60 has a heating section (heating means) 64 provided therein. The purpose of this is to shorten a period of warm-up time between a point of time where the image forming apparatus 100 is powered on and a point of time where the image forming apparatus 100 becomes ready for image formation and to prevent the pressure roller 60 from suddenly decreasing in surface temperature due to the transfer of heat to a recording medium 8 at the time of fixing of a toner image. The present embodiment uses a halogen lamp as the heating section 64.

Provided so as to face the heat roller 72 via the fixing belt 71 in the vicinity of the fixing belt 71 is a thermistor 76 that detects the temperature of the fixing belt 71. A result of detection by the thermistor 76 is inputted to a CPU.

The CPU determines, in accordance with the result of detection by the thermistor 76, whether the temperature of the fixing belt 71 as detected by the thermistor 76 falls within a setting range. In cases where the temperature of the fixing belt 71 falls short of the setting range, the CPU sends a control signal to the power supply connected to the heating sections 74 and 75, and the power supply supplies power to the heat sections 74 and 75 to facilitate heating. In cases where the temperature of the fixing belt 71 exceeds the setting range, the CPU determines whether power is being supplied to the heating sections 74 and 75. In cases where the supply of power continues, the CPU sends a control signal for stopping the supply of power.

Further disposed in the vicinity of the fixing belt 71 so as to face a second pressure roller 73 via the fixing belt 71 and be positioned on a downstream side of the rotation direction of the fixing belt 71 with respect to the thermistor 76 is a thermostat (not shown) that detects an abnormal rise in temperature of the fixing belt 71. A result of detection by the thermostat is inputted to the CPU. In accordance with the result of detection by the thermostat, the CPU stops the supply of power from the power supply connected to the heating sections 74 and 75.

The fixing roller 50, the heating roller 72, the fixing belt 71, and the pressure roller 60 constitute a fixing mechanism that is controlled by a CPU (central processing unit; not shown) which controls every operation of the image forming apparatus 100.

In response to input of an instruction for image formation, the CPU sends control signals to power supplies (not shown) that supply power to the heating sections 64, 74, and 75 provided inside of the heat roller 72 and the pressure roller 60. The instruction for image formation is inputted via an operation panel (not shown) provided on an upper surface of the image forming apparatus 100 in the vertical direction of the image forming apparatus 100 or via an external device, such as computer, connected to the image forming apparatus 100. Upon receiving the control signals, the power supplies activate the heating sections 64, 74, and 75 by supplying power to the heating sections 64, 74, and 75.

The heating sections 64, 74, and 75 heat the fixing roller 50, the heat roller 72, the pressure roller 60, and the surface of fixing belt 71 to their respective preset temperatures. When a temperature detecting sensor (not shown) provided in the vicinity of the fixing roller 50 and the pressure roller 60 detects the attainment of the preset temperatures and the result of detection is inputted to the CPU, the CPU sends a control signal to a driving mechanism (not shown; driving means) that drives the fixing roller 50 to rotate, with the result that the pressure roller 60 is driven to rotate in the direction of the arrow 56. Accordingly, the fixing belt 71, the fixing roller 50, and the heat roller 72 are driven to rotate. In this state, a recording medium 8 bearing an unfixed toner image is conveyed from the second transfer roller 31 (see FIG. 2) to the fixing nip area 55. During passage of the recording medium 8 through the fixing nip area 55, toner constituting the toner image is fixed to the recording medium 8 with heat and pressure, with the result that an image is formed.

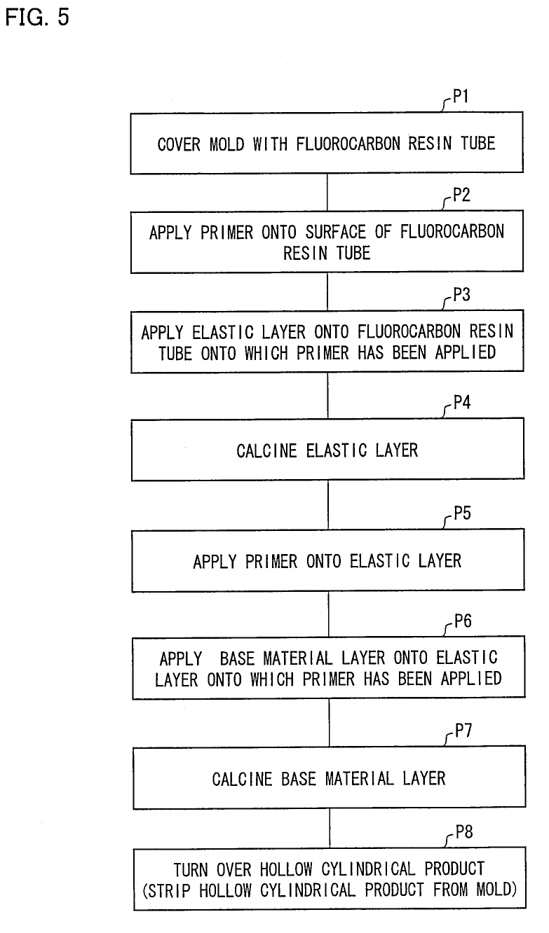

In the following, a method for manufacturing a fixing belt 71 will be described with reference to FIGS. 1 and 5. FIG. 1 is an explanatory diagram showing the way a fixing belt to be provided in a fixing device looks in course of manufacture, and FIG. 5 is a process drawing showing a procedure for manufacturing the fixing belt.

Process 1 (P1): A mold 81 is covered with a fluorocarbon resin tube so that a face that is to be a surface (outermost surface) of a fixing belt 71 makes contact with the mold 81. The fluorocarbon resin tube is to be a releasing layer 82. Usable examples of the mold 81 include: a pipe mold made of brass, stainless steel, iron, or aluminum; and a mold made of glass.

In cases where the fluorocarbon resin tube already has an etched surface, the mold 81 is covered with the fluorocarbon resin tube so that the etched surface serves as an outer circumferential surface of the tube.

Alternatively, in cases where the fluorocarbon resin tube has no etched surface, the fluorocarbon resin tube is subjected to etching after the mold 81 is covered with the fluorocarbon resin tube. The etching is performed on the outer circumferential surface of the fluorocarbon resin tube. Therefore, in comparison with the conventional etching, which is performed on an inner circumferential surface of the tube, the etching has the advantages of being performed more easily, leaving no crease in the tube by chemical treatment with a solution, etc.

Specific examples of methods for etching include, but are not particularly limited to, a method for chemical treatment with a solution obtained by dissolving metallic sodium and naphthalene in THF (tetrahydrofuran) or ethylene glycol dimethyl ether, a method for chemical treatment with a solution obtained by dissolving metallic sodium in liquid ammonia, a method for chemical treatment with a mercury amalgam of alkali metal such as lithium, a method for electrolytic reduction, a method for corona discharge treatment, a method for treatment with inert gas plasma such as helium or argon, a method for treatment with an excimer laser; and a method for forming, via an oxidizing flame of a flame burner, a nano-level silicon oxide film on a surface of an object to be coated.

Among them, in consideration of workability and the degree of improvement in adhesiveness by etching, the method for forming, via an oxidizing flame of a flame burner, a nano-level silicon oxide film on a surface of an object to be coated is preferred. This will be mentioned later.

Process 2 (P2): Next, a primer is applied onto the releasing layer 82 constituted by the fluorocarbon resin tube. It is preferable that the primer be constituted by a fluorocarbon rubber primer. Specific examples include fluorocarbon rubber such as VDF-HFP, VDF-HFP-TFE, VDF-PFP, VDF-PFP-TFE, VDF-PFMVE-TFE, and VDF-CTFE.

Further, it is preferable that the primer layer have a thickness of 1 μm to 20 μm. Within this range of thickness, the primer layer is easily applied so uniformly that there are no variations in adhesion. In particular, it is preferable that the primer layer have a thickness of 2 μm to 10 μm.

Processes 3 and 4 (P3 and P4): Next, the aforementioned material that is to be an elastic layer 83 is applied onto the primer layer and calcined at a predetermined temperature. It is preferable that the elastic layer 83 be calcined at a temperature of 150° C. to 300° C. Within this range of temperature, the elastic layer 83 neither deteriorates nor hardens while being prevented from remaining with volatile portions or lacking in strength.

Process 5 (P5): Next, a primer is applied onto the elastic layer 83. It is preferable that the primer layer have a thickness of 2 μm to 10 μm. Within this range of thickness, the primer layer improves in adhesiveness and becomes easier to apply.

Further, it is preferable that the primer layer be constituted by two layers, namely a primer for silicone rubber having a thickness of 1 μm to 5 μm and a fluorocarbon rubber primer having a thickness of 1 μm to 5 μm, because the two-layered structure causes the elastic layer 83 and the base material layer 84 to adhere more firmly to each other. Usable examples of the primer for silicone rubber include silane coupling agents such as vinylsilane, acrylsilane, epoxysilane, and aminosilane. Further, usable examples of the fluorocarbon rubber primer include fluorocarbon rubber such as VDF-HFP, VDF-HFP-TFE, VDF-PFP, VDF-PFP-TFE, VDF-PFMVE-TFE, and VDF-CTFE.

Processes 6 and 7 (P6 and P7): Next, the aforementioned material that is to be a base material layer 84 is applied onto the primer layer and calcined at a predetermined temperature. It is preferable that the base material layer 84 be calcined at a temperature of 150° C. to 300° C. Within this range of temperature, the base material layer 84 does not decrease in strength, nor the elastic layer deteriorates.

Process 8 (P8): Finally, the hollow cylindrical product 80 thus formed around the mold 81 is turned over while being stripped from the mold 81, with the result that the fixing belt 71 is obtained. The method used here for turning over the hollow cylindrical product 80 is a method for turning over the hollow cylindrical product 80 while separating the hollow cylindrical product 80 from the mold 81. However, apart from the method, there are a method for turning over the hollow cylindrical product 80 by partially turning over an end of a long side of the hollow cylindrical product 80 as stripped from the mold 81 and by injecting air into the space between the outermost base material layer 84 and the overturned portion, a method for turning over the hollow cylindrical product 80 automatically with use of a jig, and the like.

Finally, the method for forming, via an oxidizing flame of a flame burner, a nano-level silicon oxide film on a surface of an object to be coated will be described.

The silicon oxide film is formed by vaporizing a modifier compound, preparing a combustion gas from a mixture of the modifier compound and a flammable gas, and then burning the combustion gas with a burner.

Examples of the modifier compound include, but are not limited to, an alkylsilane compound, an alkoxysilane compound, an alkyltitanium compound, an alkoxytitanium compound, an alkylaluminum compound, and an alkoxyaluminum compound. It is preferable that the modifier compound have an average molecular weight of 50 to 1,000 in terms of mass spectrum measurement.

It is preferable that the density of the modifier compound in a liquid state fall within a range of 0.3 g/cm³ to 0.9 g/cm³. The reason for this is as follows: If the density of the modifier compound is less 0.3 g/cm³, the modifier compound becomes hard to handle or hard to store in an aerosol can. On the other hand, if the density of the modifier compound exceeds 0.9 g/cm³, the modifier compound becomes hard to vaporize and may be completely separated from air and the like when stored in an aerosol can. Therefore, it is more preferable that the density of the modifier compound fall within a range of 0.4 g/cm³ to 0.8 g/cm³, or still more preferably 0.5 g/cm³ to 0.7 g/cm³.

Assuming that the total amount of combustion gas is 100 mol %, it is preferable that the modifier compound be added in an amount of 1×10⁻¹⁰ mol % to 10 mol %. The reason for this is as follows: If the amount of the modified compound added is less than 1×10⁻¹⁰ mol %, the modifier compound exhibits no effect of modifying a solid substance. On the other hand, if the amount of the modified compound added exceeds 10 mol %, the modifier compound decreases in miscibility with air and the like and may be accordingly prone to incomplete combustion. Therefore, assuming that the total amount of combustion gas is 100 mol %, it is more preferable that the modifier compound be added in an amount of 1×10⁻⁹ mol % to 5 mol %, or still more preferably 1×10⁻⁸ mol % to 1 mol %.

Further, in order to facilitate control of flame temperature, it is normally preferable that a flammable gas be added to the combustion gas. Examples of such a flammable gas include: hydrocarbon gas such as propane gas and natural gas; or flammable gasses such as hydrogen, oxygen, and air. In the case of use of the combustion gas in an aerosol can, it is preferable that propane gas, compressed air, and the like be used as such inflammable gases.

Further, assuming that the total amount of combustion gas is 100 mol %, it is preferable that the content of such a flammable gas fall within a range of 80 mol % to 99.9 mol %. The reason for this is as follows: If the content of the flammable gas is less than 80 mol %, the modifier compound decreases in miscibility with air and the like and may be accordingly prone to incomplete combustion. On the other hand, if the content of the flammable gas exceeds 99.9 mol %, the modifier compound exhibits no effect of modifying a solid substance. Therefore, assuming that the total amount of combustion gas is 100 mol %, it is more preferable that the content of the flammable gas fall within a range of 1×85 mol % to 99 mol %, or still more preferably 90 mol % to 99 mol %.

In order to mix the modifier compound uniformly, it is also preferable that carrier gas be added to the combustion gas. That is, it is preferable that the modifier compound and the carrier gas be mixed together in advance and then mixed with a flow of flammable gas such as air. The reason for this is as follows: The addition of the carrier gas makes it possible that even a modifier compound having a comparatively high molecular weight and thus having difficulty in movement is mixed uniformly with airflow.

That is, the addition of the carrier gas makes it easier for the modifier compound to burn and thereby makes it possible to perform uniform and sufficient surface modification of a solid substance. It is preferable that the same type of gas as a flammable gas be used as such preferred carrier gas. Examples of the carrier gas include air, oxygen, and hydrocarbon gas such as propane gas and natural gas.

It is preferable that the flame temperature take on a value falling within a range of 500° C. to 1,500° C. The reason for this is as follows: If the flame temperature takes on a value of less than 500° C., it becomes difficult to effectively prevent incomplete combustion of the modifier compound. On the other hand, if the flame temperature exceeds 1,500° C., a solid substance to be subjected to surface modification may be thermally deformed or thermally degraded. This may impose excessive restrictions on the type of solid substance that can be used. Therefore, it is more preferable that the flame temperature take on a value falling within a range of 550° C. to 1,200° C., or still more preferably 600° C. to 900° C. It should be noted that the flame temperature can be appropriately adjusted according to the type of combustion gas that is used, the flow rate of the combustion gas, or the type and amount of a modifier compound that is added to the combustion gas.

It is preferable that the time for treatment with flame (injection time) take on a value falling within a range of 0.1 seconds to 100 seconds. The reason for this is as follows: If the time for treatment with flame takes on a value of less than 0.1 seconds, the modifier compound may not exhibit a modification effect uniformly. On the other hand, if the time for treatment with flame exceeds 100 seconds, a solid substance to be subjected to surface modification may be thermally deformed or thermally degraded. This may impose excessive restrictions on the type of solid substance that can be used. Therefore, it is more preferable that the time for treatment with flame take on a value falling within a range of 0.3 seconds to 30 seconds, or still more preferably 0.5 seconds to 20 seconds.

The conventional process of treating the inner surface of a fluorocarbon resin tube requires that a burner for throwing a flame of combustion gas be inserted into the tube, thus making the treatment difficult. Further, the flame and the tuber are so close to each other that the flame of the burner may deform the tube. As described above, it has become possible to use a method for manufacturing a fixing belt by treating the outer circumferential surface of a tube. Therefore, it has become possible to use the above treatment. The above treatment makes it possible to attach an elastic layer without use of a primer. Further, in order to enhance the adhesion between the fluorocarbon resin tube and the elastic layer, it is possible to apply a primer.

As described above, in order to solve the foregoing problems, a fixing belt of the present invention is a fixing belt, shaped into a hollow cylinder, which has a base material layer formed on an inner circumferential side thereof, has a releasing layer formed on an outer circumferential side thereof, and has an elastic layer formed between the base material layer and the releasing layer, the releasing layer being constituted by a fluorocarbon resin tube having a heat shrinkage ratio of not more than 5%.

According to this, the releasing layer formed on the outer circumferential side of the belt is constituted by the fluorocarbon resin tube. As such, the releasing layer is superior in durability to a releasing layer formed by applying a resin containing a fluorocarbon resin and calcining the resin.

Further, in the case of formation of a releasing layer by application and calcination, an attempt to obtain a releasing layer of high dimensional accuracy requires a high-precision and expensive mold. In contrast, use of a tube makes it possible to obtain a releasing layer of high dimensional accuracy without use of such a mold.

Moreover, according to this, use of a fluorocarbon resin tube, having a heat shrinkage ratio of not more than 5%, which has conventionally been unable to be used as a releasing layer makes it possible to attain equivalent effects more inexpensively than before with a wide range of material choice.

Furthermore, the fixing belt of the present invention is preferable arranged such that the fluorocarbon resin tube has a tensile strength of not less than 80 MPa.

According to this, the fluorocarbon resin tube has a tensile strength of not less than 80 MPa; that is, the fluorocarbon resin tube has a higher tensile strength than a conventional fluorocarbon resin tube does, thus rendering the fixing belt of the present invention more durable than a conventional fixing belt. Further, because of the increased tensile strength, the fluorocarbon resin tube can be made thinner than before, provided durability is maintained at the same level as is conventionally done. Therefore, the elasticity of the elastic layer can be further utilized. This makes it possible for a surface of a fixing member to follow fine undulations of a sheet of paper, thus making it possible to obtain high image quality.

The fixing belt of the present invention can be arranged such that the fluorocarbon resin tube is constituted by polytetrafluoroethylene. This makes it possible to easily obtain a fluorocarbon resin tube having a heat shrinkage ratio of not more than 5% and a tensile strength of not less than 80 MPa.

Furthermore, the fixing belt of the present invention can be arranged such that the fluorocarbon resin tube has an etched surface that comes into contact with the elastic layer.

This makes it easier to control the amount of a primer that is applied onto the surface of the fluorocarbon resin tube at the time of manufacture of the fixing belt in order to enhance adhesiveness between the elastic layer and the fluorocarbon resin, thus leading to a reduction in manufacturing cost.

Further, the present invention further encompasses: a fixing device including the fixing belt of the present invention; and an image forming apparatus including such a fixing device.

As already explained, the fixing belt of the present invention can be manufactured inexpensively with use of a fluorocarbon resin tube having a heat shrinkage ratio of not more than 5%. Therefore, he fixing device and the image forming apparatus including the same can be lowered in price. Furthermore, in cases where the fluorocarbon resin tube has a tensile strength of not less than 80 MPa, it is possible to further improve durability or, provided durability is maintained at the same level as is conventionally done, to make the fluorocarbon resin tube thinner than before. Therefore, the elasticity of the elastic layer can be further utilized. This makes it possible for a surface of a fixing member to follow fine undulations of a sheet of paper, thus making it possible to obtain a good quality image.

In order to solve the foregoing problems, a method of the present invention for manufacturing a fixing belt is a method of the present invention for manufacturing a hollow cylindrical fixing belt in which an elastic layer and a releasing layer have been provided in this order on a base material layer, the method comprising the steps of: covering an outer circumferential surface of a hollow cylindrical mold with a fluorocarbon resin tube that is to be the releasing layer; applying the elastic layer onto the fluorocarbon resin tube; calcining at a predetermined temperature the elastic layer thus applied; applying the base material layer onto the elastic layer thus calcined; calcining at a predetermined temperature the base material layer thus applied; and after the base material has been calcined, turning over a hollow cylindrical product constituted by the fluorocarbon resin tuber, the elastic layer, and the base material layer.

According to this, the fluorocarbon resin tube is used as the releasing layer formed on the outer circumferential side of the belt. Therefore, in comparison with a method for forming a releasing layer by applying a resin containing a fluorocarbon resin and calcining the resin, the method makes it possible to manufacture, without use of a high-precision and expensive mold, a fixing belt excellent in durability and having a releasing layer of high dimensional accuracy.

Moreover, the method does not utilize the heat shrinkage of a fluorocarbon resin tube. Therefore, the method makes it possible to use a fluorocarbon resin tube, having a heat shrinkage ratio of not more than 5%, which has conventionally been unable to be used as a releasing layer in a conventional method that utilizes the heat shrinkage of a fluorocarbon resin tube. This widens a range of choice of a fluorocarbon resin tube to form a releasing layer.

Furthermore, in the method of the present invention for manufacturing a fixing belt, it is possible that the step of covering the mold with the fluorocarbon resin tube further includes the step of etching a surface of the fluorocarbon resin tube with which the mold has been covered.

This makes it easier to control the amount of a primer that is applied onto the surface of the fluorocarbon resin tube in order to enhance adhesiveness between the elastic layer and the fluorocarbon resin tube, thus leading to a reduction in manufacturing cost.

Furthermore, the method of the present invention for manufacturing a fixing belt can be arranged so as to further include the step of throwing, onto a surface of the fluorocarbon resin tube with which the mold has been covered, a flame of combustion gas, containing a silane atom, a titanium atom, or an aluminum atom, which has a boiling point of 10° C. to 100° C., the step being taken between the step of covering the mold with the fluorocarbon resin tube and the step of applying the elastic layer onto the fluorocarbon resin tube.

So-called ITRO treatment of the surface of the fluorocarbon resin tube makes it possible to manufacture a fixing belt without use of a primer. This makes it possible to reduce the number of manufacturing steps, thus leading to a reduction in manufacturing cost.

A combination of primer application and ITRO treatment makes it possible to enhance adhesiveness, thus making it possible to effectively remedy a defect in adhesiveness between the elastic layer and the fluorocarbon resin tube.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A fixing belt, shaped into a hollow cylinder, which has a base material layer formed on an inner circumferential side thereof, has a releasing layer formed on an outer circumferential side thereof, and has an elastic layer formed between the base material layer and the releasing layer, the releasing layer being constituted by a fluorocarbon resin tube having a heat shrinkage ratio of not more than 5%.

2. The fixing belt as set forth in claim 1, wherein the fluorocarbon resin tube has a tensile strength of not less than 80 MPa.

3. The fixing belt as set forth in claim 1, wherein the fluorocarbon resin tube is made of polytetrafluoroethylene.

4. The fixing belt as set forth in claim 1, wherein the fluorocarbon resin tube has an etched surface that comes into contact with the elastic layer.

5. A fixing device comprising a fixing belt,
the fixing belt being shaped into a hollow cylinder, having a base material layer formed on an inner circumferential side thereof, having a releasing layer formed on an outer circumferential side thereof, and having an elastic layer formed between the base material layer and the releasing layer, the releasing layer being constituted by a fluorocarbon resin tube having a heat shrinkage ratio of not more than 5%.

6. An image forming apparatus including a fixing device, the fixing device comprising a fixing belt,
the fixing belt being shaped into a hollow cylinder, having a base material layer formed on an inner circumferential side thereof, having a releasing layer formed on an outer circumferential side thereof, and having an elastic layer formed between the base material layer and the releasing layer, the releasing layer being constituted by a fluorocarbon resin tube having a heat shrinkage ratio of not more than 5%.

7. A method for manufacturing a hollow cylindrical fixing belt in which an elastic layer and a releasing layer have been provided in this order on a base material layer, the method comprising the steps of:
covering an outer circumferential surface of a hollow cylindrical mold with a fluorocarbon resin tube that is to be the releasing layer;
applying the elastic layer onto the fluorocarbon resin tube;
calcining at a predetermined temperature the elastic layer thus applied;
applying the base material layer onto the elastic layer thus calcined;
calcining at a predetermined temperature the base material layer thus applied; and
after the base material layer has been calcined, turning over a hollow cylindrical product constituted by the fluorocarbon resin tube, the elastic layer, and the base material layer.

8. The method as set forth in claim 7, wherein the step of covering the mold with the fluorocarbon resin tube further includes the step of etching a surface of the fluorocarbon resin tube with which the mold has been covered.

9. The method as set forth in claim 7, further comprising the step of throwing, onto a surface of the fluorocarbon resin tube with which the mold has been covered, a flame of combustion gas, containing a silane atom, a titanium atom, or an aluminum atom, which has a boiling point of 10° C. to 100° C., the step being taken between the step of covering the mold with the fluorocarbon resin tube and the step of applying the elastic layer onto the fluorocarbon resin tube.
